(19) United States
(12) Patent Application Publication
(10) Pub. No.: US 2008/0171190 A1
(43) Pub. Date: Jul. 17, 2008

(54) Material for vending bottles and cans

(75) Inventor: William Charles Stevenson, Chatsworth, CA (US)

Correspondence Address: WILLIAM C. STEVENSON, 22353 DEVONSHIRE STREET, CHATSWORTH, CA, 91311, US

(73) Assignee: DB DESIGN INCORPORATED, Culver City, CA (US)

(21) Appl. No.: 11/653,051

(22) Filed: Jan. 13, 2007

(51) Int. Cl. B32B 5/18

(52) U.S. Cl. 428/314.4

(57) ABSTRACT

An improved closed cell polyethylene foam laminate material useful for fabricating critical positioning and motion absorbing elements of bottle and can vending machines is disclosed.

### BACKGROUND OF THE INVENTION

1. Field of the Invention

The present field of the invention relates to an improved material for use in manufacturing features critical to the reliable operation of can and bottle vending machines. In application, this improved material is used to fabricate spacers and fillers used to size storage bins in bottle and can vending machines. Use of this improved material may end jamming and interruptions of operation caused by misalignment that results from friction.

2. Description of the Prior Art

Product vending machines have been present in the marketplace since the Nineteenth Century. Each vending machine has the ability to store a quantity of pre-packaged products in a secure environment, then, in response to the input of a quantity of cash, one or more of the stored product packages is brought forward from the stock of stored products and dispensed to a location such as a protected shelf for the vending customer to take physical possession of their purchase.

Among the earliest popular vended products sold are bottled and canned beverages. Modern bottle and can vending machines are designed to store and vend a variety of can and bottle shapes and dimensions. This goal is accomplished by manufacturing vending machine bottle and can storage bins that are intentionally oversized relative to most available products, and then installing spacers and other devices to occupy excess space in the storage bin not occupied by the selected product bottle or can, and thus align the stored bottles or cans for most effective vending.

Such spacers and devices are common in the vending machine industry, and a relatively recent invention, closed cell polyethylene foam has been successfully employed in creating spacers, fillers and other devices of excellent performance and economical cost for these applications. Closed cell polyethylene foam has a natural manufactured surface finish that consists of a plane of polyethylene bubbles packed so close together they exhibit a surface similar to somewhat flattened soapsuds. Polyethylene is a thermoplastic that also possesses a low coefficient of friction quality, which is very desirable for this application as the various spacers and devices are in constant contact with the various irregular surfaces of moving bottles and cans, and the natural lubricating qualities of this material helps in aiding the smooth travel of bottles and cans within the vending machine. As effective as it is, the irregular surface features of closed cell polyethylene foam can still contribute to friction in the system.

When using closed cell polyethylene foam, it is also a frequent requirement that the foam be machined to a thickness less than its original manufactured dimension. This act destroys the relatively slick manufactured finish of closed cell polyethylene foam, leaving a surface that to the eye appears similar to that of a cellulose sponge. Such a machined surface contains millions of potential snagging structures that effectively destroy the friction characteristics of the native material. Further, as time passes and snags naturally occur, this surface may erode to the point of becoming unusable, and that spacer or device is then replaced at extra cost.

It is therefore an object of the present invention to produce a material that possesses self-lubricity characteristics superior to natural closed cell polyethylene foam yet retains much of the economic advantage attributable to raw closed cell polyethylene foam use. It is a further object of the present invention to provide a material having wear characteristics far superior to those of machined or cut raw closed cell polyethylene foam.

### SUMMARY OF THE INVENTION

The present invention improved material for vending bottles and cans is directed toward providing spacers, fillers and other devices to the vending industry that possess superior operating characteristics compared to any other material presently available. Applying this invention to a vending machine increases its utility, as the machine may be more easily and reliably adjusted to sell many different sized and shaped packaged beverage choices. As new beverage products become available to the vending industry, a machine using this improved spacer mechanism is less likely to become obsolete or unusable.

In an exemplary embodiment of the present invention, a smooth contiguous layer of plastic resin that also has low coefficient of friction properties (such as possessed by certain polyolefin, polypropylene, polyethylene and fluoropolymer plastic resins and resin blends) is bonded to the surface of closed cell polyethylene foam to create a more robust and smoother surfaced end product material that may also retain the ability to be die cut for economical fabrication.

In a preferred embodiment of the present invention improved material for vending bottles and cans, a laminate structure consisting of a first layer of polyethylene sheet is adhesively bonded to the natural manufactured surface of closed cell polyethylene foam.

In an alternate preferred embodiment of the present invention improved material for vending bottles and cans, a laminate structure consisting of a first layer of polypropylene sheet is adhesively bonded to the natural manufactured surface of closed cell polyethylene foam.

In a second alternate preferred embodiment of the present invention improved material for vending bottles and cans, a laminate structure consisting of a first layer of polyethylene sheet is thermally bonded to the natural manufactured surface of closed cell polyethylene foam.

In a third alternate preferred embodiment of the present invention improved material for vending bottles and cans, a laminate “sandwich” structure consisting of first and second layers of polypropylene sheet adhesively bonded to opposite parallel surfaces of manufactured closed cell polyethylene foam.

Further features and advantages of the present invention improved material for vending bottles and cans may be appreciated by a review of the following detailed description when taken in conjunction with the following drawings.

### BRIEF DESCRIPTION OF THE DRAWINGS

The present invention may be best understood by referring to the following description of the preferred embodiments and the accompanying drawings, wherein like numerals denote like elements and in which:

FIG. 1 is a sectional view of closed cell polyethylene foam having one surface machined flat.

FIG. 2 is a sectional view of a present invention laminate structure consisting of closed cell polyethylene foam having one surface covered by a solid layer of self-lubricating plastic resin.

### DETAILED DESCRIPTION OF THE PREFERRED EMBODIMENTS

The following exemplary discussion focuses upon the improved material characteristics of the present invention improvement. The present invention improvement is appropriate for use in packaged beverage vending machines that incorporate storage bin technologies such as what is commonly known as a “rolling can lane,” and another known as a “vertical column” to store and dispense essentially cylindrical bottles and cans of various sizes and lengths.

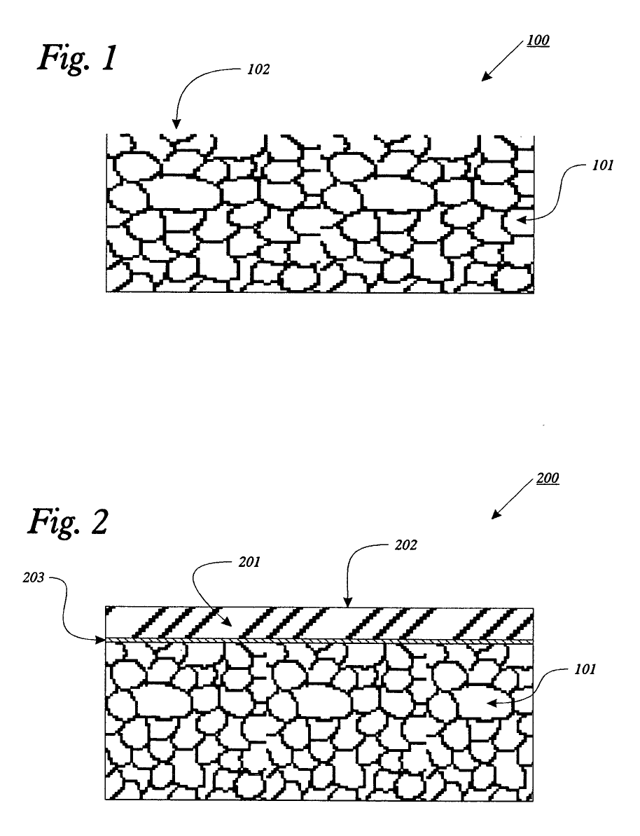

First referring to FIG. 1, a sectional view illustration 100 of the thickness of a sheet of natural finish closed cell polyethylene foam whose top surface has been machined flat. Illustrated are the cellular bubble structures 101 natural to closed cell polyethylene foam. Said cellular bubble structures 101 each consist of a very thin layer of polyethylene resin surrounding a gaseous void space, thus creating a very light-weight, strong, and resilient material suitable for many industrial and commercial applications. The upper surface 102 of this structure has been machined flat, removing the surface film layer and exposing the cell voids, which then become snagging hazards.

Now referring to FIG. 2, a sectional view of a present invention laminate structure 200 consisting of closed cell polyethylene foam 101 having one surface covered by a solid layer of self-lubricating plastic resin 201 such as polyethylene sheet that is adhesively bonded 203 to create laminate structure 200. The outer surface 202 of said laminate structure 200 is the natural manufactured surface of the laminate sheet, said surface 202 possessing excellent self-lubricating and frictional wear characteristics.

A second, easily understood sandwiched laminate structure consisting of parallel outer surfaces of self-lubricating plastic resin 201 such as polyethylene sheet enclosing closed cell polyethylene foam 101 is not illustrated.

The forgoing description includes what are at present considered to be preferred embodiments of the invention. However, it will be readily apparent to those skilled in the art that various changes and modifications may be made to the embodiments without departing from the spirit and scope of the invention. Accordingly, it is intended that such changes and modifications fall within the scope of the invention, and that the invention be limited only by the following claims.

What is claimed is:

1. An improved closed cell polyethylene foam laminate structure having at least one outer layer of self-lubricating plastic resin.

2. An improved closed cell polyethylene foam laminate structure according to claim 1 having at least one outer layer of polyethylene sheet adhesively bonded thereto.

3. An improved closed cell polyethylene foam laminate structure according to claim 1 having first and second outer layers of polyethylene sheet adhesively bonded thereto.

4. An improved closed cell polyethylene foam laminate structure according to claim 1 having at least one outer layer of polypropylene sheet adhesively bonded thereto.

5. An improved closed cell polyethylene foam laminate structure according to claim 1 having first and second outer layers of polypropylene sheet adhesively bonded thereto.

6. An improved closed cell polyethylene foam laminate structure according to claim 1 having at least one outer layer of polyester sheet adhesively bonded thereto.

7. An improved closed cell polyethylene foam laminate structure according to claim 1 having first and second outer layers of polyester sheet adhesively bonded thereto.

8. An improved closed cell polyethylene foam laminate structure according to claim 1 having at least one outer layer of nylon sheet adhesively bonded thereto.

9. An improved closed cell polyethylene foam laminate structure according to claim 1 having first and second outer layers of nylon sheet adhesively bonded thereto.

10. An improved closed cell polyethylene foam laminate structure according to claim 1 having at least one outer layer of fluropolymer sheet adhesively bonded thereto.

11. An improved closed cell polyethylene foam laminate structure according to claim 1 having first and second outer layers of fluropolymer sheet adhesively bonded thereto.

12. An improved closed cell polyethylene foam laminate structure according to claim 1 having at least one outer layer of polyethylene sheet thermally bonded thereto.

13. An improved closed cell polyethylene foam laminate structure according to claim 1 having first and second outer layers of polyethylene sheet thermally bonded thereto.
